(19) United States
(12) Patent Application Publication
(10) Pub. No.: US 2026/0310592 A1
(43) Pub. Date: Oct. 8, 2026

(54) SYSTEM AND METHOD FOR ARTIFICIAL INTELLIGENCE-BASED AUTOMATED TEST CASE DATA GENERATION AND TEST DATA MANAGEMENT

(71) Applicant: BANK OF AMERICA CORPORATION, Charlotte, NC (US)

(72) Inventors: Poornima Gayathri Mani, Chennai (IN); Manjula Balasubramanian, Chennai (IN); Prakash Durai, Suwanee, GA (US); Tarun Mathur, Plainsboro, NJ (US)

(73) Assignee: BANK OF AMERICA CORPORATION, Charlotte, NC (US)

(21) Appl. No.: 19/172,894

(22) Filed: Apr. 8, 2025

(51) Int. Cl. G06F 11/3668

(52) U.S. Cl. CPC G06F 11/3688; G06F 11/3684

(57) ABSTRACT

Systems, computer program products, and methods are described herein for artificial intelligence-based automated test case data generation and test data management. The present disclosure includes detecting a committed code, retrieving requirements data associated with the committed code from the task-tracking platform, analyzing the committed code to identify code changes, generating generated test case data, generating a test data definition in natural language format based on the generated test case data, converting the test data definition into a generated test data query, executing the generated test data query in a provisioning platform to determine whether a stored test data query exists and matches the generated test data query, and upon determining a presence of a matching stored test data query that retrieves stored test data, mapping the generated test case data to the matching stored test data query.

### TECHNOLOGICAL FIELD

Example implementations of the present disclosure relate to a system and method for artificial intelligence-based automated test case data generation and test data management.

### BACKGROUND

Currently, test data generation and automation tools lack the capability to perform integrated, end-to-end testing across complex enterprise systems. While current solutions support regression testing and synthetic data-based machine learning testing, they do not address scenarios where test data must be retrieved from multiple systems of record or disparate data sources. Enterprise-scale testing requires contextual knowledge to understand system interactions, data dependencies, and test data definitions, which often requires manual intervention. This limitation results in fragmented testing workflows, inefficiencies, and incomplete validation of system functionality. As such, there is a need for a system and method for artificial intelligence-based automated test case data generation and test data management.

### BRIEF SUMMARY

Systems, methods, and computer program products are provided for artificial intelligence-based automated test case data generation and test data management.

In one aspect, a system for artificial intelligence-based automated test case data generation and test data management is presented. The system may include a processing device, and a non-transitory storage device containing instructions, when executed by the processing device, the instructions cause the processing device to perform the steps of detecting a committed code accessible via a task-tracking platform, retrieving requirements data associated with the committed code from the task-tracking platform via natural language processing, analyzing the committed code to identify code changes using dependency analysis, abstract syntax tree processing, and static analysis, generating, using a test case generation engine, generated test case data to validate at least one of (1) the retrieved requirements data and (2) the code changes, generating a test data definition in natural language format based on the generated test case data, wherein the test data definition specifies criteria for required test data, converting the test data definition into a generated test data query, executing the generated test data query in a provisioning platform to determine whether a stored test data query exists and matches the generated test data query, and upon determining a presence of a matching stored test data query that retrieves stored test data, mapping the generated test case data to the matching stored test data query.

In some implementations, the instructions may further cause the processing device to perform the steps of upon determining the presence of the matching stored test data query that does not retrieve stored test data, generating and storing new test data in the provisioning platform and mapping the generated test case data to the matching stored test data query and the new test data, and upon determining that no matching stored test data query exists, storing the generated test data query in the provisioning platform for future test executions, generating and storing new test data in the provisioning platform, and mapping the generated test case data to the generated test data query and the new test data.

In some implementations, upon determining that no matching stored test data query exists, the system further generates metadata describing the generated test data query and associates the metadata with the generated test data query to facilitate traceability and explainability of test data retrieval.

In some implementations, the instructions may further cause the processing device to perform the steps of invoking automated test execution in a continuous integration pipeline by retrieving the generated test case data and corresponding test data query using event triggers.

In some implementations, natural language processing applied to retrieve the requirements data from the task-tracking platform may include at least one of named entity recognition, dependency parsing, and semantic similarity analysis.

In some implementations, analyzing the committed code further may include extracting an abstract syntax tree representation of the code and comparing it to a prior version of the code to determine modified dependencies.

In some implementations, the test case generation engine may include a generative artificial intelligence engine including at least one micro-language model, and wherein the test case generation engine implements reinforcement learning based on prior test execution outcomes to refine future test case generation.

In another aspect, a computer program product for artificial intelligence-based automated test case data generation and test data management is presented. The computer program product may have a non-transitory computer-readable medium having code causing an apparatus to detect a committed code accessible via a task-tracking platform, retrieve requirements data associated with the committed code from the task-tracking platform via natural language processing, analyze the committed code to identify code changes using dependency analysis, abstract syntax tree processing, and static analysis, generate, using a test case generation engine, generated test case data to validate at least one of (1) the retrieved requirements data and (2) the code changes, generate a test data definition in natural language format based on the generated test case data, wherein the test data definition specifies criteria for required test data, convert the test data definition into a generated test data query, execute the generated test data query in a provisioning platform to determine whether a stored test data query exists and matches the generated test data query, and upon determining a presence of a matching stored test data query that retrieves stored test data, map the generated test case data to the matching stored test data query.

In some implementations, the code may further cause the apparatus to, upon determining the presence of the matching stored test data query that does not retrieve stored test data, generate and store new test data in the provisioning platform and map the generated test case data to the matching stored test data query and the new test data, and upon determining that no matching stored test data query exists, store the generated test data query in the provisioning platform for future test executions, generate and store new test data in the provisioning platform, and map the generated test case data to the generated test data query and the new test data.

In some implementations, upon determining that no matching stored test data query exists, the system further generates metadata describing the generated test data query and associates the metadata with the generated test data query to facilitate traceability and explainability of test data retrieval.

In some implementations, the code may further cause the apparatus to invoke automated test execution in a continuous integration pipeline by retrieving the generated test case data and corresponding test data query using event triggers.

In some implementations, the natural language processing applied to retrieve the requirements data from the task-tracking platform may include at least one of named entity recognition, dependency parsing, and semantic similarity analysis.

In some implementations, analyzing the committed code further may include extracting an abstract syntax tree representation of the code and comparing it to a prior version of the code to determine modified dependencies.

In some implementations, the test case generation engine may include a generative artificial intelligence engine including at least one micro-language model, and wherein the test case generation engine implements reinforcement learning based on prior test execution outcomes to refine future test case generation.

In yet another aspect, a method for artificial intelligence-based automated test case data generation and test data management is presented. The method may include detecting a committed code accessible via a task-tracking platform, retrieving requirements data associated with the committed code from the task-tracking platform via natural language processing, analyzing the committed code to identify code changes using dependency analysis, abstract syntax tree processing, and static analysis, generating, using a test case generation engine, generated test case data to validate at least one of (1) the retrieved requirements data and (2) the code changes, generating a test data definition in natural language format based on the generated test case data, wherein the test data definition specifies criteria for required test data, converting the test data definition into a generated test data query, executing the generated test data query in a provisioning platform to determine whether a stored test data query exists and matches the generated test data query, and upon determining a presence of a matching stored test data query that retrieves stored test data, mapping the generated test case data to the matching stored test data query.

In some implementations, the method may further include, upon determining the presence of the matching stored test data query that does not retrieve stored test data, generating and storing new test data in the provisioning platform and mapping the generated test case data to the matching stored test data query and the new test data, and upon determining that no matching stored test data query exists, store the generated test data query in the provisioning platform for future test executions, generating and storing new test data in the provisioning platform, and mapping the generated test case data to the generated test data query and the new test data.

In some implementations, upon determining that no matching stored test data query exists, the system further generates metadata describing the generated test data query and associates the metadata with the generated test data query to facilitate traceability and explainability of test data retrieval.

In some implementations, the method may further include invoking automated test execution in a continuous integration pipeline by retrieving the generated test case data and corresponding test data query using event triggers.

In some implementations, the natural language processing applied to retrieve the requirements data from the task-tracking platform may include at least one of named entity recognition, dependency parsing, and semantic similarity analysis.

In some implementations, analyzing the committed code further may include extracting an abstract syntax tree representation of the code and comparing it to a prior version of the code to determine modified dependencies.

The above summary is provided merely for purposes of summarizing some example implementations to provide a basic understanding of some aspects of the present disclosure. Accordingly, it will be appreciated that the above-described implementations are merely examples and should not be construed to narrow the scope or spirit of the disclosure in any way. It will be appreciated that the scope of the present disclosure encompasses many potential implementations in addition to those here summarized, some of which will be further described below.

### BRIEF DESCRIPTION OF THE DRAWINGS

Having thus described implementations of the disclosure in general terms, reference will now be made the accompanying drawings. The components illustrated in the Figures may or may not be present in certain implementations described herein. Some implementations may include fewer (or more) components than those shown in the Figures.

FIGS. 1A-1C illustrate technical components of an exemplary distributed computing environment for artificial intelligence-based automated test case data generation and test data management, in accordance with implementations of the disclosure;

FIG. 2 illustrates an exemplary machine learning model subsystem architecture, in accordance with implementations of the disclosure;

FIG. 3 illustrates an exemplary generative artificial intelligence model subsystem, in accordance with implementations of the disclosure;

FIG. 4 illustrates a process flow for artificial intelligence-based automated test case data generation and test data management, in accordance with implementations of the disclosure; and

FIG. 5 illustrates a system architecture for artificial intelligence-based automated test case data generation and test data management, in accordance with implementations of the disclosure.

### DETAILED DESCRIPTION

Implementations of the present disclosure will now be described more fully hereinafter with reference to the accompanying drawings, in which some, but not all, implementations of the disclosure are shown. Indeed, the disclosure may be implemented in many different forms and should not be construed as limited to the implementations set forth herein; rather, these implementations are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” may be also used herein. Furthermore, when it may be said herein that something may be “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the entity, its products or applications, the customers or any other aspect of the operations of the entity. As such, the entity may be any institution, group, association, financial institution, establishment, company, union, authority or the like, employing information technology resources for processing large amounts of data.

As used herein, a “user” may be an individual associated with an entity. As such, in some implementations, the user may be an individual having past relationships, current relationships or potential future relationships with an entity. In some implementations, the user may be an employee (e.g., an associate, a project manager, an IT specialist, a manager, an administrator, an internal operations analyst, or the like) of the entity or enterprises affiliated with the entity.

As used herein, a “user interface” or “display” may be a point of human-computer interaction and communication in a device that allows a user to input information, such as commands or data, into a device, or that allows the device to output information to the user. For example, the user interface includes a graphical user interface (“GUI”) or an interface to input computer-executable instructions that direct a processing device to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. In some implementations, “engine” may be used interchangeably with “module” or “model”. An engine may be self-contained, but externally controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some implementations, an engine may be configured to retrieve resources created in other computer programs, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system. In some implementations, an engine may implement a machine learning model or generative artificial intelligence (“AI”) model to perform functions as a foundation for the larger piece of software that drives the functionality of the software. The machine learning model or generative AI model for any given engine may be self-contained (e.g., without interaction with other engines), or the machine learning model or generative AI model may be shared across one or more engines. In other words, some implementations of the larger piece of software many implement multiple machine learning models or generative AI models to perform functions of the various engines. In other implementations, a single machine learning model or generative AI model may be shared across one or more engines to perform the functions attributed thereto as described herein.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

It should be understood that the word “exemplary” may be used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that an element matches a predetermined criterion, including that a threshold has been met, passed, exceeded, and so on.

As used herein, a “task-tracking platform” may refer to a software-based system configured to facilitate the creation, assignment, monitoring, and management of tasks, issues, or projects within an organization or team. A task-tracking platform may include functionalities for tracking progress, setting deadlines, prioritizing work items, enabling collaboration among multiple users, and integrating with other productivity tools. The task-tracking platform may operate as a standalone application or as part of a broader project management or workflow automation system, and support various development methodologies. Additionally, the task-tracking platform may allow for the inclusion of references or comments within code repositories that specify requirements, such as testing criteria, test cases, or other necessary conditions for validation, thereby linking development tasks with corresponding implementation and verification needs.

As used herein, a “provisioning platform” may refer to may refer to a system configured to facilitate the management, allocation, and deployment of data, resources, or configurations across different environments within an organization. The provisioning platform may be in operable communication with one or more databases, including but not limited to a test environment database and a production database, to enable controlled data access, synchronization, or migration between such environments. The provisioning platform may support automated or manual provisioning processes to allow for appropriate datasets, configurations, or credentials to be available. The provisioning platform may enforce access controls, maintain data integrity, and provide auditing or logging functionalities to track data movements, modifications, or provisioning events across interconnected environments.

As used herein, “test data” may refer to any data that is used as input to a software system during the execution of a test case, for the purpose of validating that the system behaves as expected. This may include data that is used to simulate real-world conditions, verify business logic, trigger specific application flows, or the like. Test data may be retrieved from existing data sources or it may be generated synthetically to meet specific criteria required by the test. These criteria may include values for specific fields (e.g., account type, balance, status), relationships between data entities (e.g., customer linked to account), or constraints (e.g., a balance must be greater than zero). In the context of the present disclosure, test data may not be hardcoded or manually created for each test case; rather, it may be dynamically provisioned based on a test data definition, which describes the kind of data required in natural language or structured form. This definition may then be used to generate a test data query, which is executed in a provisioning platform to retrieve or create the appropriate test data for use during automated test execution.

Current solutions for test data generation and automation primarily focus on regression testing and synthetic data-based validation. This often relies on predefined datasets or machine-generated test data. These tools efficiently generate and manipulate test data within isolated systems, enabling automated testing for well-defined scenarios. However, they lack the capability to handle enterprise-scale test data retrieval that spans multiple systems of record, diverse databases, and interconnected applications. Some frameworks provide rule-based or template-driven test data generation, but these approaches do not incorporate contextual intelligence to adapt to complex testing needs where data dependencies, relationships, and business logic dictate the validity of test cases. Additionally, automation tools excel in executing predefined test scripts but do not integrate with disparate data sources in a way that ensures consistency, completeness, and accuracy of test data across an enterprise ecosystem.

The inadequacy of existing solutions is based on their inability to automate the retrieval, correlation, and validation of test data across varied enterprise systems. Testing workflows that require cross-system data retrieval still depends heavily on human intervention, as current tools do not have the necessary intelligence to interpret system interactions, infer required data sets, and dynamically assemble test data from distributed sources. This manual dependency introduces inefficiencies, prolongs testing cycle duration, and increases the likelihood of incomplete or inaccurate test coverage. The absence of an integrated, intelligent framework capable of orchestrating end-to-end test data retrieval and validation creates a long-felt need for a technical solution that eliminates reliance on manual processes, improves automation, and ensures comprehensive testing coverage in complex enterprise environments.

Addressing these challenges requires the establishment of a system and method for artificial intelligence-based automated test case data generation and test data management, which introduces an AI-driven system that integrates with software development environments to automate test case generation, manage test data provisioning, and execute tests in response to committed code changes. By implementing natural language processing (“NLP”), static and dependency analysis, generative artificial intelligence (“AI”), and reinforcement learning, the system may automatically extract software requirements, analyze code changes, generate test cases, and convert test data definitions into structured test data queries. These queries interact with a test data provisioning platform (i.e., a “provisioning platform”) such that the system dynamically retrieves or generates test data as needed. This provides for consistency and reusability across test executions within software development. The system, when integrated within Continuous Integration and Continuous Deployment (“CI/CD”) workflows, eliminates or reduces the need for manual test data mapping, thereby providing an intelligent, explainable, and scalable solution for enterprise software testing.

To do so, the system may identify new code that has been committed and made accessible via a task-tracking platform. Using natural language processing, the system may extract relevant requirements data related to the committed code from the task-tracking platform. The system may examine the committed code to detect modifications by using dependency analysis, abstract syntax trees (“AST”), static analysis, or the like. A test case generation engine may create test case data to validate either the retrieved requirements or the identified code changes, or both. The system may translate the generated test cases into a natural language definition that specifies the criteria for required test data. The test data definition may be transformed into a query to locate relevant stored test data. The system may run the query within a provisioning platform to check if matching test data already exists. If matching stored test data is found, the system may map the generated test cases to the existing test data. If a matching query exists but does not retrieve data, new test data may be created and stored, and the test cases may be mapped accordingly. If no matching query exists, the system may save the generated query, create new test data, and map it to both the query and test cases. Metadata describing the query may be generated and linked to it for better traceability and explainability. The system may automatically run tests in a continuous integration (“CI”) pipeline by retrieving relevant test case data and test data queries. The system may use techniques like named entity recognition, dependency parsing, and semantic similarity analysis to refine requirements retrieval. The system may generate an AST representation of the code and compare it to a previous version to determine changes. The test case generation engine may include a micro-language model and apply reinforcement learning based on past test outcomes to improve future test generation.

What is more, the present disclosure provides a technical solution to a technical problem. As described herein, the technical problem includes the inefficiency and manual effort required for generating and managing test cases and test data in software development pipelines, particularly in CI/CD environments, where traditional methods fail to dynamically adapt to changing software requirements and code changes. The present disclosure embraces an improvement over existing solutions by allowing for automated test case generation, test data query execution, and test data provisioning in response to committed code change (i) with fewer steps to achieve the solution (e.g., eliminating the need for manual test case creation and test data assignment by using natural language processing to extract requirements and AI-driven test data provisioning), thus reducing the amount of network resources, such as processing resources, storage resources, network resources, and/or the like, that are being used, (ii) providing a more accurate solution to problem, thus reducing the number of resources required to remedy any errors made due to a less accurate solution (e.g., utilizing generative AI models for test case generation and reinforcement learning to continuously improve test accuracy, reducing false positives/negatives in test execution), (iii) removing manual input and waste from the implementation of the solution, thus improving speed and efficiency of the process and conserving network resources (e.g., automatically converting test data definitions into structured test data queries, mapping them to test cases, and dynamically retrieving or generating test data without human intervention), (iv) determining an optimal amount of resources that need to be used to implement the solution, thus reducing network traffic and load on existing network resources (e.g., storing test data queries and associated mappings in a repository for reuse, thereby reducing redundant query execution and test data generation, optimizing database interactions, and minimizing unnecessary computational overhead). In other words, the solution may bypass a series of steps previously implemented, thus further conserving network resources. Furthermore, the technical solution described herein uses a rigorous, computerized process to perform specific tasks and/or activities that were not previously performed.

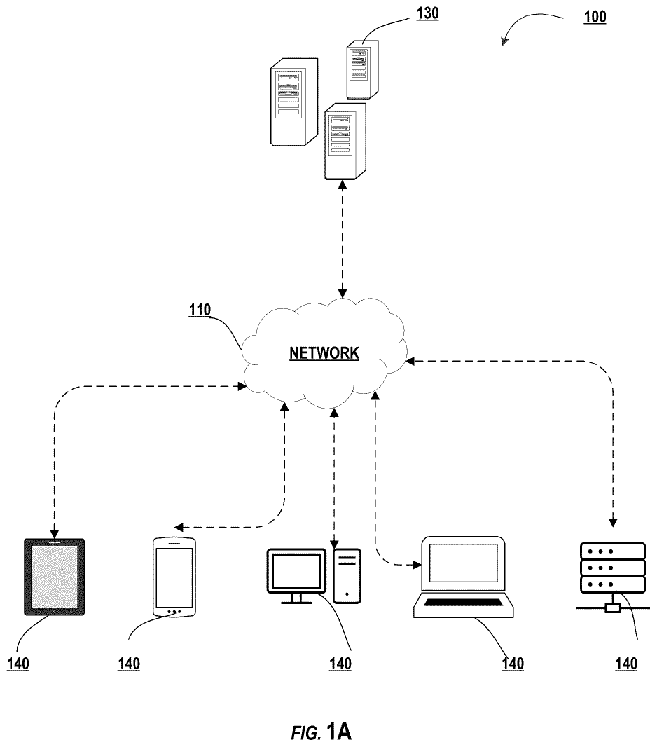

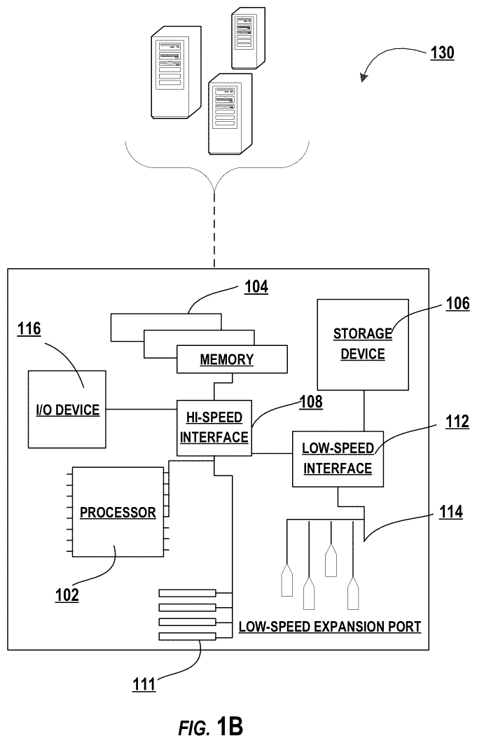

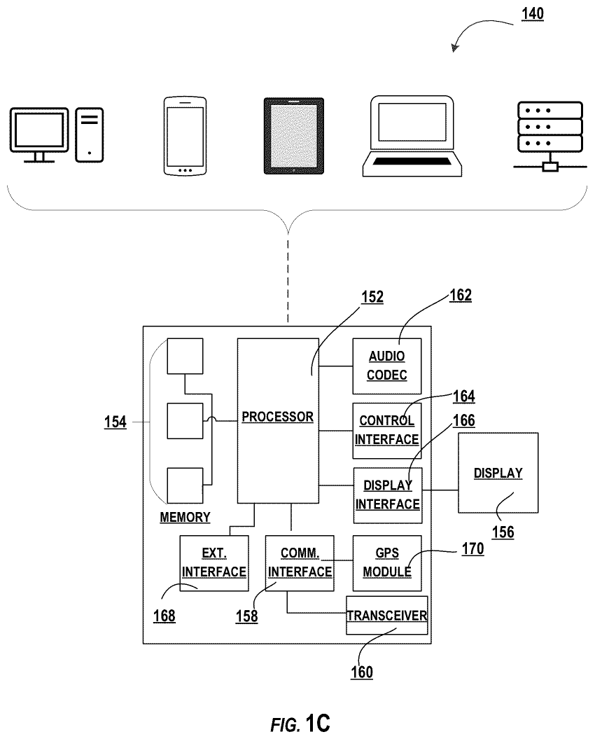

FIGS. 1A-1C illustrate technical components of an exemplary distributed computing environment 100 for artificial intelligence-based automated test case data generation and test data management, in accordance with implementations of the disclosure. As shown in FIG. 1A, the distributed computing environment 100 contemplated herein may include a system 130, an endpoint device(s) 140, and a network 110 over which the system 130 and endpoint device(s) 140 communicate therebetween. FIG. 1A illustrates only one example of an implementation of the distributed computing environment 100, and it will be appreciated that in other implementations one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some implementations, the system 130 and the endpoint device(s) 140 may have a client-server relationship in which the endpoint device(s) 140 are remote devices that request and receive application from a centralized server, i.e., the system 130. In some other implementations, the system 130 and the endpoint device(s) 140 may have a peer-to-peer relationship in which the system 130 and the endpoint device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The endpoint device(s) 140 may represent various forms of electronic devices, including user input devices such as personal digital assistants, cellular telephones, smartphones, laptops, desktops, and/or the like, input devices such as resource transfer terminals, electronic resource transfer units, and/or the like, electronic telecommunications device (e.g., automated teller machine (“ATM”)), and/or edge devices such as routers, routing switches, integrated access devices (“IAD”), and/or the like.

The network 110 may be a distributed network that is spread over different networks. This provides a single data communication network, which can be managed jointly or separately by each network. In addition to shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with implementations of the disclosure. As shown in FIG. 1B, the system 130 may include a processing device 102, memory 104, input/output (“I/O”) device 116, and a storage device 106. The system 130 may also include a high-speed interface 108 connecting to the memory 104, and a low-speed interface 112 connecting to a low-speed bus 114 and a storage device 106. Each of the components 102, 104, 108, 110, and 112 may be operatively coupled to one another using various buses and may be mounted on a common motherboard or in other manners as appropriate. As described herein, the processing device 102 may include a number of subsystems to execute the portions of processes described herein. Each subsystem may be a self-contained component of a larger system (e.g., system 130) and capable of being configured to execute specialized processes as part of the larger system.

The processing device 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processing devices, along with multiple memories, and/or I/O devices, to execute the processes described herein. In other words, as used herein, a “processing device” means one processing device (e.g., a microprocessor) that performs the defined functions or a plurality of processing devices (e.g., microprocessors) that collectively perform defined functions such that the execution of the individual defined functions may be divided amongst such processing devices.

The memory 104 stores information within the system 130. In one implementation, the memory 104 is a volatile memory unit or units, such as volatile random access memory (“RAM”) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly implemented in an information carrier. The computer program product may also contain instructions that, when executed, perform one or more methods, such as those described above. The information carrier may be a non-transitory computer-or machine-readable storage medium, such as the memory 104, the storage device 106, or memory on processing device 102.

The high-speed interface 108 manages bandwidth-intensive operations for the system 130, while the low-speed controller 112 manages lower bandwidth-intensive operations. Such allocation of functions is exemplary only. In some implementations, the high-speed interface 108 is coupled to memory 104, input/output (“I/O”) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the endpoint device(s) 140, in accordance with implementations of the disclosure. As shown in FIG. 1C, the endpoint device(s) 140 includes a processing device 152, memory 154, an input/output device such as a display 156, a communication interface 158, and a transceiver 160, among other components. The endpoint device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processing device 152 is configured to execute instructions within the endpoint device(s) 140, including instructions stored in the memory 154, which in one implementation includes the instructions of an application that may perform the functions disclosed herein, including certain logic, data processing, and data storing functions. The processing device may be implemented as a chipset of chips that include separate and multiple analog and digital processors. The processing device may be configured to provide, for example, for coordination of the other components of the endpoint device(s) 140, such as control of user interfaces, applications run by endpoint device(s) 140, and wireless communication by endpoint device(s) 140.

The processing device 152 may be configured to communicate with the user through control interface 164 and display interface 166 coupled to a display 156. The display 156 may be, for example, a “TFT LCD” (Thin-Film-Transistor Liquid Crystal Display) or an “OLED” (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processing device 152. In addition, an external interface 168 may be provided in communication with processing device 152, so as to enable near area communication of endpoint device(s) 140 with other devices. External interface 168 may provide, for example, for wired communication in some implementations, or for wireless communication in other implementations, and multiple interfaces may also be used.

The memory 154 stores information within the endpoint device(s) 140. The memory 154 can be implemented as one or more of a computer-readable medium or media, a volatile memory unit or units, or a non-volatile memory unit or units. Expansion memory may also be provided and connected to endpoint device(s) 140 through an expansion interface (not shown), which may include, for example, a “SIMM” (Single In Line Memory Module) card interface. Such expansion memory may provide extra storage space for endpoint device(s) 140 or may also store applications or other information therein. In some implementations, expansion memory may include instructions to carry out or supplement the processes described above and may include secure information also. For example, expansion memory may be provided as a security module for endpoint device(s) 140 and may be programmed with instructions that permit secure use of endpoint device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly implemented in an information carrier. The computer program product contains instructions that, when executed, perform one or more methods, such as those described herein. The information carrier is a computer-or machine-readable medium, such as the memory 154, expansion memory, memory on processing device 152, or a propagated signal that may be received, for example, over transceiver 160 or external interface 168.

In some implementations, the user may use the endpoint device(s) 140 to transmit and/or receive information or commands to and from the system 130 via the network 110. Any communication between the system 130 and the endpoint device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the endpoint device(s) 140 may provide the system 130 (or other client devices) permissioned access to the protected resources of the endpoint device(s) 140, which may include a GPS device, an image capturing component (e.g., camera), a microphone, and/or a speaker.

The endpoint device(s) 140 may communicate with the system 130 through communication interface 158, which may include digital signal processing circuitry where necessary. Communication interface 158 may provide for communications under various modes or protocols, such as the Internet Protocol (“IP”) suite (commonly known as “TCP/IP”). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, “GPS” (Global Positioning System) receiver module 170 may provide additional navigation- and location-related wireless data to endpoint device(s) 140, which may be used as appropriate by applications running thereon, and in some implementations, one or more applications operating on the system 130.

The endpoint device(s) 140 may also communicate audibly using audio codec 162, which may receive spoken information from a user and convert the spoken information to usable digital information. Audio codec 162 may likewise generate audible sound for a user, such as through a speaker, e.g., in a handset of endpoint device(s) 140. Such sound may include sound from voice telephone calls, may include recorded sound (e.g., voice messages, music files, etc.) and may also include sound generated by one or more applications operating on the endpoint device(s) 140, and in some implementations, one or more applications operating on the system 130.

Various implementations of the distributed computing environment 100, including the system 130 and endpoint device(s) 140, and techniques described here can be realized in digital electronic circuitry, integrated circuitry, specially designed “ASICs” (application specific integrated circuits), computer hardware, firmware, software, and/or combinations thereof.

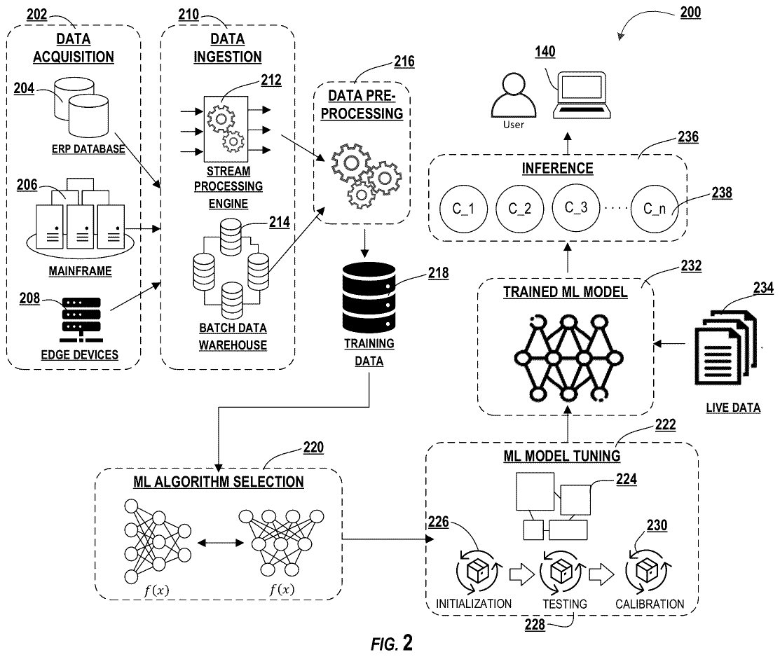

FIG. 2 illustrates an exemplary machine learning model subsystem architecture 200, in accordance with implementations of the disclosure. The machine learning subsystem 200 may include a data acquisition engine 202, data ingestion engine 210, data pre-processing engine 316, machine learning model tuning engine 222, and inference engine 236.

The data acquisition engine 202 may identify various internal and/or external data sources to generate, test, and/or integrate new features for training the machine learning model. These internal and/or external data sources 204, 206, and 208 may be initial locations where the data originates or where physical information is first digitized. The data acquisition engine 202 may identify the location of the data and describe connection characteristics for access and retrieval of data. In some implementations, data is transported from each data source 204, 206, or 208 using any applicable network protocols, such as the File Transfer Protocol (“FTP”), Hyper-Text Transfer Protocol (“HTTP”), or any of the myriad Application Programming Interfaces (“APIs”) provided by websites, networked applications, and other applications. In some implementations, the these data sources 204, 206, and 208 may include Enterprise Resource Planning (“ERP”) databases or protocol databases that host data related to day-to-day enterprise activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of network resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points. As will be understood in view of the present disclosure, training data 218 may additionally, or alternatively, be provided from a third party, having been generated as synthetic data.

The machine learning model tuning engine 222 may be used to train a machine learning model to form a trained machine learning model 232 using the training data 218 to make predictions or decisions without explicitly being programmed to do so. The machine learning model 232 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms can adjust their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the machine learning model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the machine learning model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical enterprise decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It shall be understood that the implementation of the machine learning subsystem 200 illustrated in FIG. 2 is exemplary and that other implementations may vary. As another example, in some implementations, the machine learning subsystem 200 may include more, fewer, or different components.

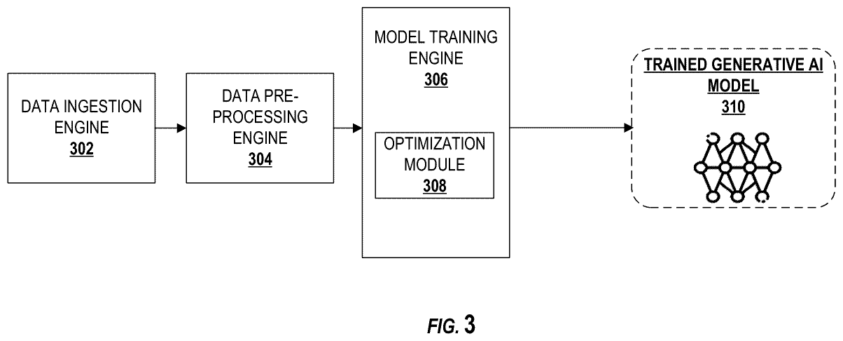

FIG. 3 illustrates an exemplary generative AI subsystem 300, in accordance with implementations of the disclosure. The generative AI subsystem 300 may include a data ingestion engine 302, a data pre-processing engine 304, and a model training engine 306. It should be understood that the generative AI subsystem 300 is merely an example, and other implementations may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 300 should not be considered limiting and may be adapted to various configurations within the scope of the disclosure.

The data ingestion engine 302 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 302 may support decentralized storage systems, such as blockchain-based data sources, and privacy-preserving methods such as differential privacy. The data ingestion engine 302 may identify the location of the data and describe connection characteristics for access and retrieval of data. In some implementations, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some implementations, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 302 may move the data to a destination for storage or further analysis. Typically, the data may be in varying formats as they come from different sources, including RDBMS, other types of databases, S3 buckets, CSVs, or from streams. For a large language model (“LLM”), text data may originate from sources such as web scrapes, social media, large public text datasets, or the like. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, or any other logical ordering.

In machine learning, the quality of data and the useful information that can be derived therefrom directly affects the ability of the machine learning model to learn. The data pre-processing engine 304 may implement advanced integration and processing steps needed to prepare the data for machine learning execution, including tokenization, text normalization, and removal of irrelevant elements like HTML tags in web-based data, especially for LLM training. This may include modules to perform any upfront, data transformation to consolidate the data into alternate forms by changing the value, structure, or format of the data using generalization, normalization, attribute selection, and aggregation, text-specific transformations such as stemming and lemmatization, data cleaning by filling missing values, smoothing the noisy data, resolving the inconsistency, and removing outliers, and/or any other encoding steps as needed. In some implementations, the data pre-processing engine 304 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 304 may transform categorical data into numerical formats that are suitable for machine learning algorithms. In this regard, the data pre-processing engine 304 may use techniques such as one-hot encoding or label encoding depending on the nature of the categorical variables and the intended use of the data.

In some implementations, the data pre-processing engine 304 may also include dimensionality reduction techniques, where the number of input features is reduced while retaining the most relevant information. In this regard, the data pre-processing engine 304 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 304 may then be fed into the model training module 306.

The model training engine 306 may be responsible for training the generative AI models 310 using the pre-processed data from the data pre-processing engine 304. The model training engine 306 may implement various machine learning algorithms, including but not limited to Generative Adversarial Networks (GANs), Variational Autoencoders (VAEs), transformers, diffusion models, or other specialized architectures depending on the specific requirements of the system. These models may be used in a broad range of applications, such as LLMs for text generation, image generation models, video synthesis models, audio generation models, and/or the like. The model training engine 306 may optimize these models by continuously adjusting their internal parameters based on the patterns and relationships identified within the data.

In some implementations, the model training engine 306 may include a training data handler, which manages the partitioning of the pre-processed data into training, validation, and testing datasets. The training data is used to update the model's parameters, while the validation and testing datasets are reserved to evaluate the model's performance during and after training. The model training engine 306 may support various data-handling strategies, such as cross-validation or random shuffling, to ensure that the model generalizes well and is not overfitting to the training data.

In implementations involving large language models, the model training engine 306 may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In implementations involving image generation models, the model training engine 306 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 306 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 306 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models 310, the model training engine 306, which may include an optimization module 308, may implement various optimization techniques to improve model performance and efficiency. The optimization module 308 may be responsible for continuously adjusting the internal parameters of the model using feedback from relevant loss functions tailored to the application (e.g., text, image, audio, or video generation). Techniques such as gradient clipping, learning rate scheduling, and mixed-precision training may be applied by the optimization module 308 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some implementations, the model training engine 306 may implement early stopping mechanisms to prevent overfitting. Early stopping monitors the generative AI model performance on the validation dataset, halting the training process if the performance does not improve after a specified number of iterations. This ensures that the generative AI model does not continue training on noise or irrelevant patterns, which could degrade its performance on unseen data. The model training engine 306 may also support distributed training across multiple computing nodes, allowing the system to scale its computational resources as needed. Distributed training may involve splitting the generative AI model and data across multiple machines or GPUs, where each node processes a portion of the data and updates the model in parallel. This may be particularly useful for large datasets or models that require significant computational power, such as deep generative models. The model training engine 306 may synchronize the updates across the nodes using techniques like synchronous or asynchronous gradient descent.

Once the generative AI model is trained, the model training engine 306 may save the final trained generative AI model 310 in a persistent storage location for future use. In specific implementations, metadata such as the number of epochs, the final loss values, and values of learned parameters may be logged for model versioning and/or retraining at a later stage. In some implementations, the model training engine 306 may also implement transfer learning, where a pre-trained model may be fine-tuned on a smaller, domain-specific dataset. This may reduce the amount of time and data required to train a new model, especially in cases where the available data may be limited or highly specialized. The model training engine 306 may adjust the parameters of the pre-trained model to better align with the new dataset, while preserving the learned features from the original training.

In implementations involving LLMs, new output may be generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters which influence the randomness of the token sampling, enabling the generation of diverse or deterministic responses.

In image generation models, such as those using ViTs or GANs, new output may be generated by sampling from the learned distribution in the model's latent space. For GANs, the generator network creates an image by transforming random noise vectors into structured image outputs through a series of layers that learn visual features like shapes, textures, and colors. The generated image may be then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some implementations, generative AI models 310 may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the implementation of the generative AI subsystem 300 illustrated in FIG. 3 is exemplary and that other implementations may vary. The generative AI subsystem 300, as well as its constituent elements, may vary, and modifications or alternative configurations may be implemented without departing from the broader scope of the disclosure. For instance, different machine learning algorithms, data sources, optimization techniques, or training methodologies may be employed depending on system requirements, application domain, and available computational resources. Furthermore, features and functionalities described in one implementation may be combined with those of another implementation as needed, and vice versa.

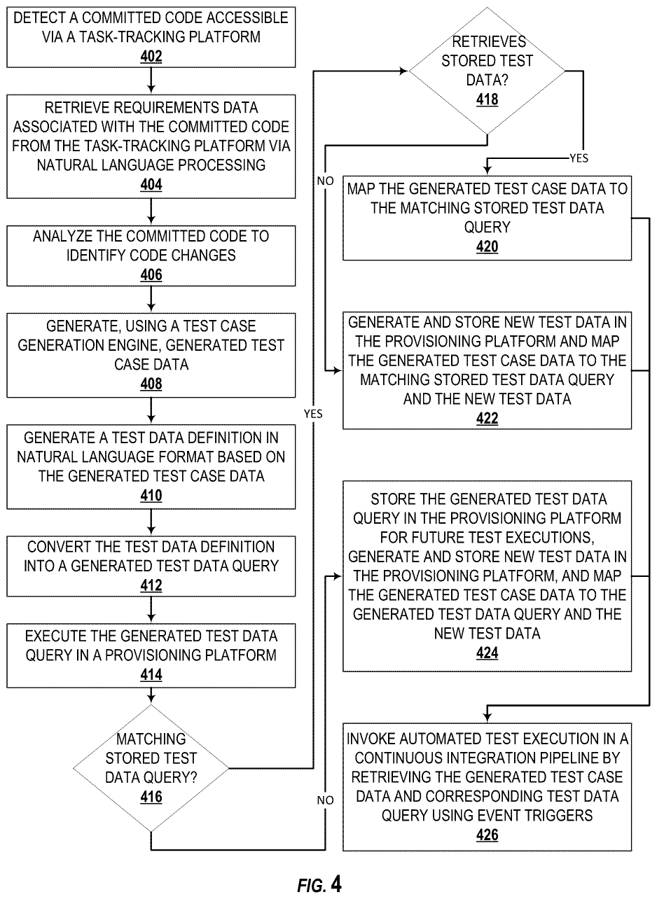

FIG. 4 illustrates a process flow for artificial intelligence-based automated test case data generation and test data management, in accordance with implementations of the disclosure. At block 402 of FIG. 4, the system 130 may detect a committed code accessible via a task-tracking platform. A “code commit” may refer to a discrete modification or addition to source code of a software project that has been formally submitted, by a developer or otherwise, to a version control system of the task-tracking platform, thereby creating a documented record of changes.

The system may identify the occurrence of a code commit through detection of metadata and change logs maintained within the task tracking platform. Upon submission of a commit, the version control system of the task tracking platform may generate a unique identifier (e.g., commit hash) associated with that particular commit, record the author, timestamp, and commit message, and/or updates internal pointers or references indicating the integration of the code modification into the codebase of the project.

In response to detecting the code commit, the system 130 may, at block 404, retrieve requirements data associated with the committed code from the task-tracking platform via natural language processing. It should be appreciated that committed code within a task-tracking platform may be accompanied by requirements data. As used herein, “requirements data” may refer to structured and unstructured information stored within a task-tracking platform that defines the functional, technical, and/or business expectations for a software feature, update, or fix. The requirements data may include requirement descriptions, acceptance criteria, issue types (e.g., user stories, bugs, tasks, or the like), linked dependencies, priority levels, assigned developers, status updates, historical revisions, or the like. Additionally, or alternatively, requirements data may include attachments, comments, and references to related issues or test cases that provide contextual understanding of the intended software behavior.

Indeed, natural language processing (NLP) may be used to interpret requirements descriptions from the requirements data and extract relevant testing criteria. In some implementations, the natural language processing applied to retrieve the requirements data from the task-tracking platform may include at least one of named entity recognition, dependency parsing, and semantic similarity analysis.

For example, named entity recognition (NER) may be used to identify system modules, user roles, actions, expected outcomes, or the like. Dependency parsing may be applied to analyze the grammatical structure of the requirement descriptions such that the system can determine relationships between different entities, such as which components interact with each other, or which conditions must be met for a particular feature to function as expected. Semantic similarity analysis may be used to compare newly introduced requirements with previously stored requirements, identifying overlapping functionality, potential conflicts, or areas where existing test cases may be reused or modified to validate the new implementation.

In some implementations, NLP models may be fine-tuned to extract relevant information from requirements data stored in a task-tracking platform. To improve precision, the system may utilize fine-tuned micro-models or large language models, depending on the complexity of the test case scenario. These models may be trained on domain-specific datasets, incorporating historical requirement descriptions, software specifications, and prior test cases to improve their contextual understanding. Additionally, reinforcement learning techniques may allow the NLP models to continuously improve their interpretation capabilities as new requirements are introduced.

At block 406, the system may analyze the committed code to identify code changes using dependency analysis, abstract syntax tree processing, and static analysis. The system 130 may analyze the committed code to determine structural and functional changes using dependency analysis, abstract syntax tree (AST) processing, and static analysis. These analyses allow the system to assess the impact of the committed code on existing functionality and identify new areas requiring validation.

In some implementations, analyzing the committed code may further include extracting an abstract syntax tree representation of the code and comparing it to a prior version of the code to determine modified dependencies. Extraction of an abstract syntax tree from source code may occur via parsing algorithms that dissect source code into discrete syntactic constructs. Parsing may include tokenization of the code, application of grammatical rules, construction of hierarchical node structures corresponding to the original programming constructs, or the like.

Upon generation of ASTs for sequential or iterative versions of code, comparative analysis between AST representations may be performed by traversing their corresponding node structures and identifying discrepancies. By determining differences between AST nodes in successive code iterations, changes in dependency structures may be detected, such as addition or removal of function invocations, alteration in variable scope or usage, shifts in inheritance and class references, or the like.

At block 408, the system may generate, using a test case generation engine, generated test case data. It shall be appreciated that test case data may be used to validate the functionality of the committed code by ensuring that it meets the specified software requirements and does not introduce unintended errors or regressions. As such, the generated test case data may include structured test scenarios, input conditions, expected outputs, and pass/fail criteria, which collectively define how the system under test should behave. Indeed, the generated test data may be used to validate retrieved requirements data and the code changes.

In some implementations, the test case generation engine may include a generative artificial intelligence engine including at least one micro-language model for generating the test case data. A “micro-language model” may refer to a compact language-processing architecture designed with significantly reduced parameter counts and resource requirements compared to conventional, larger-scale language models. Due to their smaller scale, micro-language models may provide advantages including rapid inference speeds, lower computational overhead, and minimized power consumption.

In some implementations, the test case generation engine may implement reinforcement learning based on prior test execution outcomes to refine future test case generation. In such implementations, a reinforcement learning agent may evaluate prior executions (historical experiences) based on interactions with the environment. During each interaction, the agent may select actions according to its learned policy, executes those actions, and subsequently receives feedback in the form of rewards or consequences. This feedback may update the internal model of the agent, which may influence future decisions.

At block 410, the system may generate a test data definition in natural language format based on the generated test case data. A test data definition may be a structured, natural language representation of the test data requirements needed to execute a generated test case. After the system generates test case data, it may ensure that the necessary test data is available for validation. However, rather than directly mapping test cases to specific, pre-existing test data, the system may first generate a test data definition, which serves as an intermediate abstraction layer between the test case and the actual test data retrieval process. This definition may be formulated based on the structure and parameters of the generated test case. In doing so, data attributes beneficial for test execution may be captured. The test data definition may include context-specific criteria, such as data type (e.g., customer account, transaction record, API response), constraints (e.g., balance must be greater than zero, transaction status must be “approved”), and relational dependencies (e.g., a loan account must be associated with an existing customer identifier). This structured yet human-readable definition allows the system to determine how test data should be retrieved, generated, or modified without relying on hardcoded data mappings.

At block 412, the system may convert the test data definition into a generated test data query. Once the test data definition is established, it may be converted into a structured test data query that can be executed in a provisioning platform. The test data definition provides a high-level specification of the required test data, while the test data query translates this into a format that the provisioning platform can process. By defining test data requirements in a natural language format first, the system ensures that test data generation and retrieval remain adaptive and reusable across multiple test cases, rather than being tightly coupled to individual test executions. This approach may also facilitate traceability and explainability, which may allow testers to review and validate how test data is determined before execution. Furthermore, if no existing test data matches the criteria defined in the test data definition, the system may use it to generate synthetic test data that meets the specified constraints, as is described in greater detail herein.

To convert the test data definition into a generated test data query, the system may apply a series of NLP and rule-based translation techniques to extract structured data constraints from the natural language definition. The system may use named entity recognition to identify relevant fields and values, dependency parsing to determine logical relationships between them, and semantic role labeling to understand the function of each element within the test data definition. Once the entities and conditions are extracted, the system may map them to known data schema elements used by the provisioning platform. This mapping may rely on a set of predefined templates, translation rules, domain-specific query generation models, or the like. In some implementations, the system may utilize fine-tuned language models trained on historical test data definitions and provisioning queries to improve the accuracy and relevance of the generated query. The resulting output may be a structured test data query that expresses the criteria from the test data definition in a syntax compatible with a provisioning platform, such as SQL or a domain-specific query language.

At block 414, the system may execute the generated test data query in a provisioning platform. At block 416, the system determines whether a matching stored test data query is present in the provisioning platform. This determination may be performed in one or more different ways. In some implementations, the system may perform an exact match comparison by checking whether an identical query string or query identifier already exists within the provisioning platform's catalog of stored queries. In other implementations, the system may use a semantic comparison technique, wherein the logical structure and output criteria of the generated test data query are compared to existing queries using query normalization, abstract syntax tree representations, or hashing techniques that evaluate structural equivalency despite differences in syntax. The system may also compute similarity scores between the generated test data query and stored queries using natural language embeddings or vectorized representations derived from the original test data definitions to assess functional equivalence. In some implementations, metadata associated with stored queries (such as required input fields, filters, or the like) may be compared to those of the generated test data query to determine whether they target overlapping data populations.

If a matching stored test data query is present in the provisioning platform, the process may continue at block 418, where the system determines if the matching stored test data query retrieves stored test data. In some implementations, the system may execute the stored test data query directly against one or more underlying test data sources, such as relational databases, data lakes, or synthetic data repositories, and assess whether the result set is non-empty. Alternatively, or additionally, the system may invoke a pre-execution metadata scan or query plan simulation, where the provisioning platform evaluates the query logic without fully executing it, to estimate the likelihood or existence of data matching the specified conditions. Alternatively, or additionally, the system may utilize indexing or materialized view metadata to quickly identify whether any records satisfy the query parameters, which reducing the need for full query execution and improves operational efficiency. In other implementations, the system may perform a probabilistic or heuristic-based check, using statistical summaries, data sampling, or historical query result metrics to infer whether the data likely exists.

Upon a condition where a matching stored test data query retrieves stored test data, the process may continue at block 420 where the system maps the generated test case data to the matching stored test data query. In some implementations, the system may create a direct reference link between the unique identifiers of the generated test case data and the stored test data query, such that the test execution engine can resolve the appropriate query at runtime. In other implementations, the system may maintain a mapping table or associative data structure in a test definition repository, where generated test case metadata, such as requirement identifiers, test scenario descriptors, or code module associations, is paired with the corresponding stored query metadata. The mapping may also include version control information.

Alternatively, upon a condition where the matching stored test data query does not retrieve stored test data, the process may continue at block 422, where the system may generate and store new test data in the provisioning platform. In some implementations, the system may synthesize the new test data based on the original test data definition that was used to generate the query, such that the generated new test data adheres to constraints such as as data types, value ranges, relational dependencies, and business rules. The system may generate the new test data using rule-based generators, AI-driven synthetic data models, templates that correspond to typical test data schemas, or the like. The new test data may then be formatted according to the schema expected by the provisioning platform and inserted into appropriate storage layers, such as staging databases, virtualized datasets, or isolated test environments.

Also at block 422, in a similar way as that which is described at block 420, the system may map the generated test case data to the matching stored test data query and the new test data. Indeed, in some implementations, the system may create a direct reference link between the unique identifiers of the generated test case data and the stored test data query, as well as the generated new test data, such that the test execution engine can resolve the appropriate query at runtime. In other implementations, the system may maintain a mapping table or associative data structure in a test definition repository, where generated test case data metadata and new test data (e.g., that which was generated) metadata, such as requirement identifiers, test scenario descriptors, or code module associations, is paired with the corresponding stored test data query metadata. The mapping may also include version control information.

In the context of block 422, the system generates and stores new test data in the provisioning platform in addition to mapping the generated test case data to the matching stored test data query and the new test data to ensure that future executions of the same test case, or any other test case linked to the same query, can retrieve consistent, valid test data without requiring regeneration. Even though a matching stored test data query already exists, it may not retrieve any data due to the underlying dataset being incomplete, outdated, or missing records that meet the required conditions defined in the test data definition. By populating the provisioning platform with newly generated test data that satisfies the query criteria, the system effectively transforms the matching stored test data query from a logical placeholder into an operational mechanism for automated test data retrieval. This approach improves test case reusability, continuity, stability, and/or the like.

If, at block 416, the system determines that no matching stored test data query is present in the provisioning platform, the process may continue at block 424, where system may store the generated test data query in the provisioning platform for future test executions. Storing the query enables the system to avoid unnecessary recomputation and allows future test cases with similar data requirements to reuse the same query, improving overall efficiency and consistency in test data provisioning.

In some implementations, the system may register the generated test data query along with associated metadata, such as creation timestamp, originating test case identifiers, requirement references, and environment constraints (e.g., test region, regulatory context, data sensitivity, or the like). This metadata supports query traceability and facilitates intelligent filtering or selection of test data queries during future test case execution. The generated test data query may also be versioned, allowing the system to manage updates when test data definitions evolve due to changes in requirements or application logic.

Also at block 424, in the same or similar way as described with respect to block 422, the system may generate and store new test data in the provisioning platform. Indeed, in some implementations, the system may synthesize the new test data based on the original test data definition that was used to generate the query, such that the generated new test data adheres to constraints such as data types, value ranges, relational dependencies, and business rules. The system may generate the new test data using generative artificial intelligence synthetic data models, rule-based generators, templates that correspond to typical test data schemas, or the like. The new test data may then be formatted according to the schema expected by the provisioning platform and inserted into appropriate storage layers, such as staging databases, virtualized datasets, or isolated test environments.

Also at block 424, the system may map the generated test case data to the generated test data query and the new test data. Indeed, in some implementations, the system may create a direct reference link between the unique identifiers of the generated test case data and the generated test data query, as well as the new test data previously generated, such that the test execution engine can resolve the appropriate query at runtime. In other implementations, the system may maintain a mapping table or associative data structure in a test definition repository, where generated test case data metadata and new test data (e.g., that which was generated) metadata, such as requirement identifiers, test scenario descriptors, or code module associations, is paired with the corresponding generated test data query metadata. The system may generate metadata describing the generated test data query and associate the metadata with the generated test data query to facilitate traceability and explainability of test data retrieval. The mapping may also include version control information.

At block 426, regardless of the outcome of the queries of blocks 416 and 418, the system may invoke automated test execution in a continuous integration pipeline by retrieving the generated test case data and corresponding test data query using event triggers. The event trigger may be initiated in response to a commit event, a status change in a task-tracking platform, or a scheduled CI/CD job. Upon invocation, the system may access the test definition repository to retrieve the mapped test case data and its associated test data query. The query may be executed in the provisioning platform to retrieve or synthesize test data as needed, and the test case may be executed against the retrieved data in an integrated testing tool.

In some implementations, the test execution may be managed by an orchestration layer within a CI/CD framework, which coordinates test environment setup, test script execution, result collection, and/or the like. The system may support parallel execution of test cases or selective execution based on scope of code change or test coverage requirements. In certain implementations, the system may further implement a feedback mechanism to analyze test results and adapt future test case generation or data definitions based on observed outcomes.

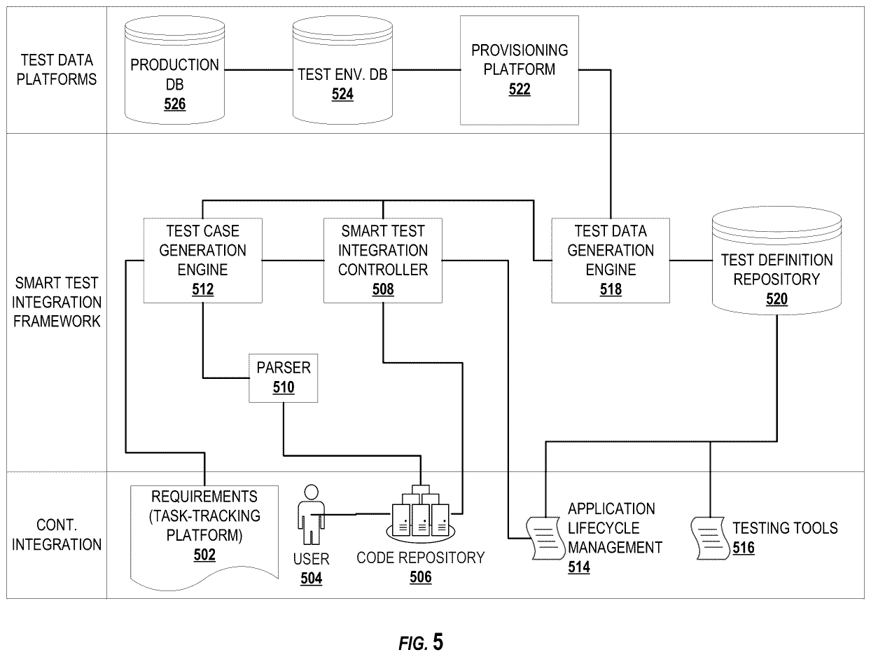

FIG. 5 illustrates an exemplary system architecture for artificial intelligence-based automated test case data generation and test data management, in accordance with some implementations of the disclosure. The architecture in FIG. 5 provides for automated, adaptive test case and test data generation integrated directly into the software delivery lifecycle.

The process may begin with requirements data retrieved from a task-tracking platform 502, which are consumed by the test case generation engine 512. The test case generation engine also interfaces with a parser 510, which may analyze committed code from the code repository 506. The parser may extract syntactic and structural information like abstract syntax trees, dependency mappings, and static code indicators, which the test case generation engine may use in combination with the interpreted requirements to generate test cases. The user 504 may interface with the code repository to initiate code commits or updates. The smart test integration controller 508 may link to both the code repository and the test case generation engine, and act as a centralized orchestrator to handle event detection, dependency resolution, task scheduling, and/or the like.

Once the test cases have been generated, both the test case generation engine 512 and the smart test integration controller 508 may provide input to the test data generation engine 518, which may construct test data definitions describing the data needs of each test case. These definitions may be stored, along with corresponding mappings, in the test definition repository 520. The test data generation engine may convert each test data definition into a structured query and interact with a provisioning platform 522 to identify, retrieve, or synthesize suitable test data. The provisioning platform may be linked to a test environment database 524, which may in turn draw from a production database 526 to provision datasets. In parallel, the smart test integration controller may push the generated test cases into an application lifecycle management system 514, which coordinates execution via downstream testing tools 516. These tools, in turn, may reference the test definition repository 520 for both test case metadata and test data associations.

As previously described, the subject matter described herein is directed to a specific, computer-implemented system that improves the functionality of software testing infrastructure by automating the generation, management, and execution of test cases and test data in response to committed source code changes. The system addresses a technical problem. Namely, the inefficiency, inaccuracy, and manual overhead of conventional test data and test case generation within continuous integration environments, by implementing a non-generic, rule-based and machine learning-based architecture. The system executes the operations described herein through integrated modules, including a test case generation engine, a test data generation engine, and a smart test integration controller, where each perform specialized data processing functions. These components work together to produce concrete outputs such as structured test case artifacts and executable test data queries that are used in test automation frameworks. The disclosed system does not merely apply generic computing functions, and instead provides a technical improvement to the field of automated software testing by providing traceable, reusable, and adaptive test coverage to reduces manual input and improve data resource utilization, amongst other technical improvements.

As will be appreciated by one of ordinary skill in the art, the present disclosure may be implemented as an apparatus (including, for example, a system, a machine, a device, a computer program product, and/or the like), as a method (including, for example, an enterprise process, a computer-implemented process, and/or the like), as a computer program product (including firmware, resident software, micro-code, and the like), or as any combination of the foregoing. Many modifications and other implementations of the present disclosure set forth herein will come to mind to one skilled in the art to which these implementations pertain having the benefit of the teachings presented in the foregoing descriptions and the associated drawings. Although the Figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for artificial intelligence-based automated test case data generation and test data management, the system comprising:
a processing device; and
a non-transitory storage device comprising instructions, when executed by the processing device, the instructions cause the processing device to perform steps of:
detecting a committed code accessible via a task-tracking platform;
retrieving requirements data associated with the committed code from the task-tracking platform via natural language processing;
analyzing the committed code to identify code changes using dependency analysis, abstract syntax tree processing, and static analysis;
generating, using a test case generation engine, generated test case data to validate at least one of (1) the retrieved requirements data and (2) the code changes;
generating a test data definition in natural language format based on the generated test case data, wherein the test data definition specifies criteria for required test data;
converting the test data definition into a generated test data query;
executing the generated test data query in a provisioning platform to determine whether a stored test data query exists and matches the generated test data query; and
upon determining a presence of a matching stored test data query that retrieves stored test data, mapping the generated test case data to the matching stored test data query.

2. The system of claim 1, wherein the instructions further cause the processing device to perform the steps of:
upon determining the presence of the matching stored test data query that does not retrieve stored test data, generating and storing new test data in the provisioning platform and mapping the generated test case data to the matching stored test data query and the new test data; and
upon determining that no matching stored test data query exists, storing the generated test data query in the provisioning platform for future test executions, generating and storing new test data in the provisioning platform, and mapping the generated test case data to the generated test data query and the new test data.

3. The system of claim 2, wherein upon determining that no matching stored test data query exists, the system further generates metadata describing the generated test data query and associates the metadata with the generated test data query to facilitate traceability and explainability of test data retrieval.

4. The system of claim 1, wherein the instructions further cause the processing device to perform the steps of:
invoking automated test execution in a continuous integration pipeline by retrieving the generated test case data and corresponding test data query using event triggers.

5. The system of claim 1, wherein the natural language processing applied to retrieve the requirements data from the task-tracking platform comprises at least one of named entity recognition, dependency parsing, and semantic similarity analysis.

6. The system of claim 1, wherein analyzing the committed code further comprises extracting an abstract syntax tree representation of the code and comparing it to a prior version of the code to determine modified dependencies.

7. The system of claim 1, wherein the test case generation engine comprises a generative artificial intelligence engine comprising at least one micro-language model, and wherein the test case generation engine implements reinforcement learning based on prior test execution outcomes to refine future test case generation.

8. A computer program product for artificial intelligence-based automated test case data generation and test data management, the computer program product comprising a non-transitory computer-readable medium comprising code causing an apparatus to:
detect a committed code accessible via a task-tracking platform;
retrieve requirements data associated with the committed code from the task-tracking platform via natural language processing;
analyze the committed code to identify code changes using dependency analysis, abstract syntax tree processing, and static analysis;
generate, using a test case generation engine, generated test case data to validate at least one of (1) the retrieved requirements data and (2) the code changes;
generate a test data definition in natural language format based on the generated test case data, wherein the test data definition specifies criteria for required test data;
convert the test data definition into a generated test data query;
execute the generated test data query in a provisioning platform to determine whether a stored test data query exists and matches the generated test data query; and
upon determining a presence of a matching stored test data query that retrieves stored test data, map the generated test case data to the matching stored test data query.

9. The computer program product of claim 8, wherein the code further causes the apparatus to:
upon determining the presence of the matching stored test data query that does not retrieve stored test data, generate and store new test data in the provisioning platform and map the generated test case data to the matching stored test data query and the new test data; and
upon determining that no matching stored test data query exists, store the generated test data query in the provisioning platform for future test executions, generate and store new test data in the provisioning platform, and map the generated test case data to the generated test data query and the new test data.

10. The computer program product of claim 9, wherein upon determining that no matching stored test data query exists, the system further generates metadata describing the generated test data query and associates the metadata with the generated test data query to facilitate traceability and explainability of test data retrieval.

11. The computer program product of claim 8, wherein the code further causes the apparatus to:
invoke automated test execution in a continuous integration pipeline by retrieving the generated test case data and corresponding test data query using event triggers.

12. The computer program product of claim 8, wherein the natural language processing applied to retrieve the requirements data from the task-tracking platform comprises at least one of named entity recognition, dependency parsing, and semantic similarity analysis.

13. The computer program product of claim 8, wherein analyzing the committed code further comprises extracting an abstract syntax tree representation of the code and comparing it to a prior version of the code to determine modified dependencies.

14. The computer program product of claim 8, wherein the test case generation engine comprises a generative artificial intelligence engine comprising at least one micro-language model, and wherein the test case generation engine implements reinforcement learning based on prior test execution outcomes to refine future test case generation.

15. A method for artificial intelligence-based automated test case data generation and test data management, the method comprising:
detecting a committed code accessible via a task-tracking platform;
retrieving requirements data associated with the committed code from the task-tracking platform via natural language processing;
analyzing the committed code to identify code changes using dependency analysis, abstract syntax tree processing, and static analysis;
generating, using a test case generation engine, generated test case data to validate at least one of (1) the retrieved requirements data and (2) the code changes;
generating a test data definition in natural language format based on the generated test case data, wherein the test data definition specifies criteria for required test data;
converting the test data definition into a generated test data query;
executing the generated test data query in a provisioning platform to determine whether a stored test data query exists and matches the generated test data query; and
upon determining a presence of a matching stored test data query that retrieves stored test data, mapping the generated test case data to the matching stored test data query.

16. The method of claim 15, wherein the method further comprises:
upon determining the presence of the matching stored test data query that does not retrieve stored test data, generating and storing new test data in the provisioning platform and mapping the generated test case data to the matching stored test data query and the new test data; and
upon determining that no matching stored test data query exists, store the generated test data query in the provisioning platform for future test executions, generating and storing new test data in the provisioning platform, and mapping the generated test case data to the generated test data query and the new test data.

17. The method of claim 16, wherein upon determining that no matching stored test data query exists, the system further generates metadata describing the generated test data query and associates the metadata with the generated test data query to facilitate traceability and explainability of test data retrieval.

18. The method of claim 15, wherein the method further comprises:
invoking automated test execution in a continuous integration pipeline by retrieving the generated test case data and corresponding test data query using event triggers.

19. The method of claim 15, wherein the natural language processing applied to retrieve the requirements data from the task-tracking platform comprises at least one of named entity recognition, dependency parsing, and semantic similarity analysis.

20. The method of claim 15, wherein analyzing the committed code further comprises extracting an abstract syntax tree representation of the code and comparing it to a prior version of the code to determine modified dependencies.
